(19) United States
(12) Patent Application Publication
(10) Pub. No.: US 2008/0272344 A1
(43) Pub. Date: Nov. 6, 2008

(54) Conductive polymer composites

(75) Inventors: HongJin Jiang, Marietta, GA (US); Kyoung-sik Moon, Duluth, GA (US); Yi Li, Atlanta, GA (US); Ching Ping Wong, Berkeley lake, GA (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 12/077,812

(22) Filed: Mar. 21, 2008

Related U.S. Application Data
(60) Provisional application No. 60/896,642, filed on Mar. 23, 2007.

(51) Int. Cl. H01B 1/22

(52) U.S. Cl. 252/513; 252/500; 252/514

(57) ABSTRACT

The present invention relates generally to conductive polymer composites, electrically conductive adhesives, and methods of producing the same. The conductive polymer composites and electrically conductive adhesives may be used for electronic component interconnects, flip chip interconnections, electrical connections to circuit boards, jumper connections, or similar uses. The method of forming a conductive polymer composite includes mixing conductive metal flakes, functionalized conductive metal nanoparticles, and a polymer precursor and curing the polymer precursor to form a composite. In one embodiment, the conductive polymer composites may be composed of microparticles of silver flake and sintered silver nanoparticles between the silver flakes. The polymer composites have an electrical conductivity of less than 10⁻⁵ Ω·cm.

### CROSS-REFERENCE TO RELATED APPLICATIONS

This application claims benefit, under 35 U.S.C. § 119(e), from U.S. Provisional Application Ser. No. 60/896,642 filed on Mar. 23, 2007, the entire contents of which are hereby incorporated by reference.

### BACKGROUND

1. Field of the Invention

The present invention relates generally to conductive polymer composites, electrically conductive adhesives, and methods of producing the same. The conductive polymer composites and electrically conductive adhesives may be used for electronic component interconnects, flip chip interconnections, electrical connections to circuit boards, jumper connections, or similar uses.

2. Description of Related Art

Polymer composites comprising nanoparticles have been developed and tested for various applications due to their potential for a variety of unique electrical, thermal, mechanical, and/or optical properties. However, the practical implementation of such polymer composites has proven difficult. Particularly, the homogeneous dispersion of the nanoparticles into a polymer matrix has been a bottleneck for the fabrication of homogeneous polymer composites comprising nanoparticles.

The polymer matrix and inorganic particles often possess different polarities. Simple blending of nanoparticles with polymer precursors will result in the formation of aggregates of nanoparticles. One method to overcome formation of aggregates and cause a more uniformly dispersed nanoparticles in the polymer matrix is to functionalize the nanoparticle surface with organic surfactants prior to forming the composite precursor. If the nanoparticles are surface functionalized with organic surfactants, they are more compatible with the polymer matrix and have a reduced tendency to agglomerate or aggregate.

Many types of organic compounds have been used as surfactants to functionalize the surfaces of silver nanoparticles. The surfaces of silver nanoparticles have been functionalized with thiol, pyridine, fatty acids, carboxylic acids, dicarboxylic acids, oligimers, polymer chains, and other surfactants. It was been found that the dicarboxylate groups of certain surfactants will chelate to silver surface sites on the surface of the nanoparticle. The molecule gains sufficient stability by bonding two carboxylate groups to the surface, and the molecule is therefore able to adopt less favorable chain conformations, for example, polymethylene groups may, therefore, be arranged in a way best to accomplish the chelating of both carboxylate groups.

Polymer composite materials have the potential for applications in electronic packaging due to their low-temperature processability and the ability to tailor their properties by changing the components. Since silver filled polymer composites were first patented as electrically conductive adhesives (“ECA's”) in 1956, the ECA's have been proposed as one of the alternatives of tin/lead (Sn/Pb) solders. Lead has long been known as a health hazard to human beings. Thus, worldwide regulation of the use of lead in electronics has been proposed or implemented. For these reasons, the elimination of lead from interconnected materials has been a long felt need in the electronics industry.

There are several other potential advantages to use of ECA's, such as low temperature processability, no flux is required to form the connection attachment by using flexible polymers, a more flexible connection may be made, and ECA's are capable of finer stencil printing than conventional solder. However, conventional ECA's have significantly lower electrical conductivity than Sn/Pb solder connections.

Therefore, there exists a need for a highly conductive polymer composite that does not require lead as a component and provides a reliable low resistance mechanical and electrical connection for electrical components.

### SUMMARY

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

This invention relates to conductive polymer composites, electrically conductive adhesives, and their methods of production. One aspect of this invention is a polymer composite, made of both a polymer and electrically conductive filler. The filler contains silver flakes and has sintered electrically conductive nanoparticles between the silver flakes.

Another aspect of this invention relates to a method of forming the polymer composite. In accordance with this method, conductive metal flakes, functionalized conductive metal nanoparticles, and a polymer precursor are mixed to form a composite precursor. This composite precursor is then cured to form a polymer composite, and the conductive metal nanoparticles are sintered.

### BRIEF DESCRIPTION OF THE DRAWINGS

FIG. 1 is a schematic of electrical connections using ECA's including conductive fillers in a polymer between the metal pads, where FIG. 1(a) is a polymer composite comprising silver flakes as the filler; FIG. 1(b) is a polymer composite comprising silver flakes and silver nanoparticles as the fillers; and FIG. 1(c) is a polymer composite comprising sintered silver nanoparticles and silver flakes as the fillers;

FIG. 2 is a graph of the x-ray diffraction (“XRD”) patterns of the synthesized silver nanoparticles;

FIG. 3(a) is a graph of the differential scanning calorimetry curve for silver nanoparticles treated with diacids and FIG. 3(b) is a graph of the thermogravimetric analysis curve of silver nanoparticles treated by diacids;

FIG. 4 includes photomicrographs of the morphologies of silver nanoparticle powders before and after various heat treatment methods, where FIG. 4(a) is a photomicrograph of non-annealed surface functionalized silver nanoparticles; FIG. 4(b) is a photomicrograph of surface functionalized silver nanoparticles annealed at 150° C. for 30 minutes; FIG. 4(c) is a photomicrograph of untreated silver nanoparticles annealed at 100° C. for 30 minutes; FIG. 4(d) is a photomicrograph of surface functionalized silver nanoparticles annealed at 100° C. for 30 minutes;

FIG. 5 is a graph of the bulk resistivity of the polymer composites with silver flakes and surface functionalized silver nanoparticles as conductive fillers;

FIG. 6 is a graph of the curing behavior of polymer composites without fillers and with silver flakes and surface functionalized silver nanoparticles in a ratio of 6:4 as fillers;

FIG. 7 shows scanning electron microscope (“SEM”) images of polymer composites, where FIG. 7(a) is an SEM image of silver flakes and surface functionalized silver nanoparticles in a ratio of 6:4 as the fillers and FIG. 7(b) is an SEM image of silver flakes and untreated silver nanoparticles in a ratio of 6:4 as the fillers;

FIG. 8 is a graph of the electrical contact resistance of polymer composites over aging time, where FIG. 8(a) is the contact resistance in ohms shift for treated and untreated and FIG. 8(b) is the contact resistance of polymer composites with different fillers.

### DETAILED DESCRIPTION

To facilitate an understanding of the principles and features of the invention, it is explained hereinafter with reference to its implementation in an illustrative embodiment. In particular, the invention is described in the context of conductive polymer composites and methods of forming conductive polymer composites.

The present invention is directed to a polymer composite comprising a polymer and electrically conductive metal filler, such as silver filler. The electrically conductive metal filler provides a network of electrically conductive metal particles within a polymer matrix to provide a pathway for electrical conductivity through the polymer composite. In embodiments of the composite of the invention, the electrically conductive filler may comprise silver flakes, typically microparticles, and sintered silver nanoparticles. The polymer composite may be an electrically conductive polymer composite. In certain embodiments, the electrically conductive polymer composite has an electrical conductivity of less than 10⁻⁵ Ω·cm.

The conductive metal of the conductive metal flakes and the conductive metal nanoparticles may be any metal capable of providing electrical conductive properties to the composite. For example, the conductive metal of the flakes and nanoparticles may be at least one conductive metal selected from silver, iron, copper, nickel, chromium, gold, platinum, palladium, aluminum or combinations thereof. In certain embodiments, the conductive metal may be exposed to an oxidizing environment; therefore, preferably the oxides of conductive metal should also be conductive; oxides of silver are electrically conductive, for example.

For applications of ECA's, the concentration of electrically conductive metal flakes in the polymer composite must be sufficient to result in electrical communication through the composite in at least one direction, preferably the electrical properties of the polymer composite are isotropic. In embodiments of the polymer composite, the concentration of electrically conductive metal is in the range of 50 wt % to 90 wt % of the total weight of the polymer composite, or preferably in some adhesive applications, in the range of 60 wt % to 80 wt % of the total weight of the polymer composite.

Embodiments of the polymer composites of the invention may comprise any suitable polymer that may form a composite of electrically conductive metal particles, such as an epoxy. In certain embodiments, the polymer may be a thermoplastic or thermosetting polymer.

As used herein, “nanoparticles” (or nanopowders) are small particles having at least one dimension less than 100 nm, more specifically; a nanoparticle has at least one dimension between 10 nm and 100 nm. Nanoparticles may have a relatively large (>15%) size dispersion. Significantly, the properties of materials change as their size approaches the nanoscale and as the percentage of atoms at the surface of a material becomes significant. The interesting properties of nanoparticles are partly due to the surface properties of the material influencing the overall properties more than the bulk properties, because nanoparticles have a very high surface area to volume ratio. Importantly in embodiments of the invention, sintering of nanoparticles may take place at lower temperatures and over shorter period of time than sintering of larger particles of similar composition. The large surface area to volume ratio of nanoparticles may also cause a reduction in the melting temperature of nanoparticles. Conductive metal nanoparticles may be prepared by combustion chemical vapor condensation methods.

As used herein, sintering is defined as heating particles of a metal or ceramic to a sintering temperature below its melting point that results in the particles adhering to each other. In most cases the density of a collection of particles will increase as material flows into voids, causing a decrease in overall volume less voids, and higher density. Some flow and diffusion of the material may occur during sintering resulting in a reduction of total porosity by repacking, followed by material transport due to evaporation and condensation. The adhered or fused particles may result in a decreased electrical resistance in the case of conductive metals. Advantageously, conductive metal nanoparticles generally sinter at a lower temperature than microscale conductive metal flakes. It is believed that the smaller particles sinter at a lower temperature due to the larger surface energy of the nanoparticles.

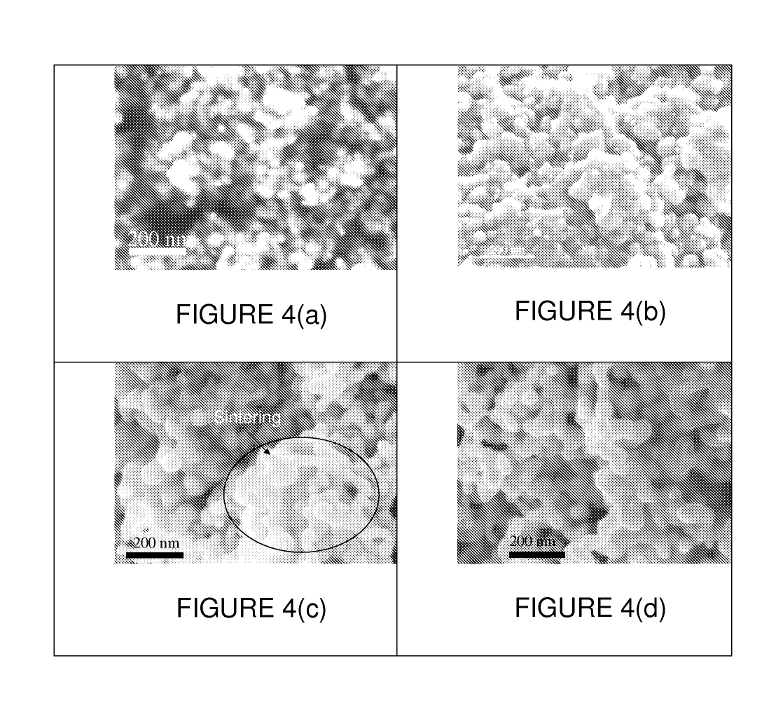

The term “sintered conductive metal nanoparticles” or “sintered silver nanoparticles” are used to describe nanoparticles that are at least partially sintered and are fused or otherwise adhered together with other nanoparticles or microparticles. Therefore, the sintered nanoparticles will no longer have the structure of nanoparticles as described above. FIGS. 4(b)-(d) depict sintered silver nanoparticles.

As used herein, “microparticles” are particles having a smallest dimension between 0.1 μm and 100 μm. Microparticles include conductive metal flakes in this size range, such as silver flakes. However, it should be noted that the conductive metal flakes do not have any size limitation for use in the invention, for typical ECA applications, though, the conductive metal flakes will be larger than nanoparticles and predominantly in the microparticle size range.

Embodiments of the invention include a method of forming a conductive polymer composite comprising mixing conductive metal flakes, conductive metal nanoparticles, and a polymer precursor to form a composite precursor. In one embodiment, silver nanoparticles and silver flakes were both incorporated into an epoxy resin as conductive fillers. Fabrication of composites comprising nanoparticles may be difficult; one of the problems is forming a homogeneous dispersion of the nanoparticle fillers in the polymer matrix. This is at least partly due to the large surface area of nanoparticles relative to their volume. When this ratio is large, the viscosity of the formulation is also larger. For this reason, it is relatively challenging to formulate highly filled homogeneous composites comprising nanoparticles. Thus, to enhance the dispersion and to increase nanoparticle filler loadings in the epoxy resin, organic surfactants may be used to surface functionalized silver nanoparticles. According to Moskovits's work[ate], hereby incorporated by reference, diacids were selected to functionalize the silver nanoparticle surface in this study.

Surfactants and lubricants may be added to the electrically conductive nanoparticles to make them more compatible with the composite precursor and to prevent agglomeration of the nanoparticles. Several compounds have been used to surface functionalized silver nanoparticles. These compounds include monocarboxylic acids, dicarboxylic acids, organic surfactants, and combinations thereof. Embodiments of the method of the invention comprise reacting conductive metal nanoparticles with a compound, wherein the compound reacts with the conductive metal nanoparticles to form a functionalized conductive metal nanoparticles comprising a surfactant.

Any compounds that may be used in the invention are capable of binding with the electrically conductive nanoparticle sufficiently to allow dispersion of the nanoparticle throughout the polymer and the surfactant has a debonding temperature from the nanoparticle that is below the sintering temperature of the electrically conductive nanoparticle. The surfactant has a chain length of C₁-C₈ or preferably, from C₁-C₄. Longer chain lengths may hinder the sintering of the nanoparticles in the polymer matrix.

The compounds react to form silver nanoparticles surface functionalized with a surfactant. The surfactant may be bonded to the silver nanoparticles by any means, such as, but not limited to, coordination bonds, ionically bonded, bonded by Vander Waal or other forces to the silver nanoparticle. As used herein, the term “bonded” means that the surfactant and the particle are associated with each other by any force or attachment means including chemical, electrical, or mechanical interaction. In a preferred embodiment, the surfactant may be thermally debonded from the conductive metal nanoparticle at or above a debonding temperature. Debonding temperature may be determined by differential scanning calorimetry, for example. The surface functionalized nanoparticle may be more easily distributed homogeneously into the polymer matrix, however, the surfactant may increase the electrical resistance of the composite by the insulating properties of the surfactant or by raising the sintering temperature or degree of adhesion of the sintered electrically conductive nanoparticles. In such case, the electrical conductivity of the polymer composite may be negatively impacted by the presence of the surfactant. In certain embodiments, it may be desirable for at least a portion of the surfactant to be thermally debonded from the conductive metal nanoparticle during curing of the polymer. Therefore, in certain embodiments, it may be desirable for the sintering temperature of the electrically conductive nanoparticles to be above the debonding temperature.

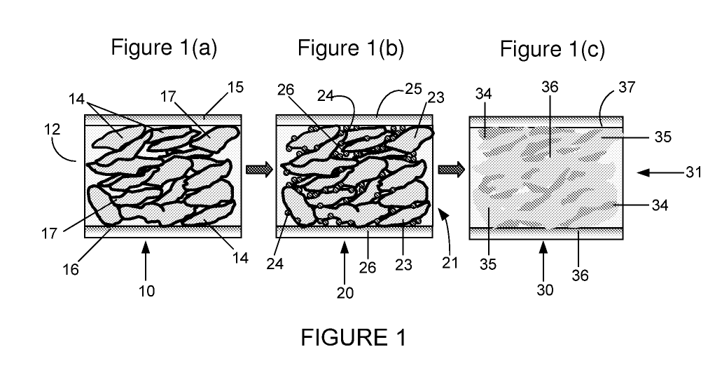

FIG. 1 is a schematic of electrical connections using ECA's including conductive fillers in a polymer between the metal pads. FIG. 1(a) is a prior art connection 10 comprising a polymer composite 12 comprising silver flakes 14 as the electrically conductive filler. It can be clearly seen that the electrical conductivity between contact pad 15 and contact pad 16 relies on the contact points 17 between the silver flakes 14. The polymer matrix between the silver flakes 14 is not a conductive material and therefore does not add to the overall electrical conductivity of the polymer composite. FIG. 1(b) depicts an improved embodiment over the embodiment in FIG. 1(a). Connection 20 includes a polymer composite 21 comprising silver flakes 23 and silver nanoparticles 24 as the fillers. The nanoparticles 24 partially fill the gaps 26 and provide further electrical communication between the flakes 23, thereby reducing the electrical resistance of the polymer composite 21 between contact pad 25 and contact pad 26. An embodiment of a connection 30 of the invention is depicted in FIG. 1(c). Connection 30 includes a polymer composite 31 comprising sintered silver nanoparticles 34 and silver flakes 35 as the fillers. The sintered silver nanoparticles 34 more completely fill the gaps 36 between the silver flakes 35, reduce the number of contact points, and provide improved electrical communication between contact pad 36 and contact pad 37.

The method comprises curing the polymer precursor to form a composite and sintering the conductive metal nanoparticles. In the composites with both silver flakes and silver nanoparticles as conductive fillers, when the nanoparticles are fused or sintered together, the number of contact points between both fillers will be reduced, see FIG. 1(c). The sintered nanoparticles fill the gaps between the flakes to form a more conductive network of metal with fewer contact points and improved conductivity with less resistance. Fewer, more intimate contact points lead to lower contact resistance. In order to improve the electrical properties of the polymer composites, low temperature sintering of nanoparticles in the polymer matrix is utilized.

Previous researchers have reported that the nano silver filled composites showed higher bulk resistivity than the micron sized silver flakes filled ones, the resistivities of 10⁻² Ω·cm and 10⁻⁴ Ω·cm from 60 wt % nano silver and 70 wt % silver flakes loadings, respectively. In some cases, nano silver filled composites showed unmeasurable resistivity and non conductive behavior. This increased bulk resistivity of nano silver filled polymer composites is due to the increased number of contact points between nanoparticles comparing to the same weight percent of silver flakes.

In embodiments of the method of the invention, both silver flakes and surface functionalized silver nanoparticles were incorporated into the polymer matrix and their electrical properties were studied. The interfacial properties between the surfactants, flakes and nanoparticles, and the electrical properties of the composites as well as their morphologies are discussed.

The ratio of electrically conductive flakes to nanoparticles depends on the composition, shape, and morphology of the flakes and nanoparticles. The concentration of nanoparticles should be sufficient to decrease the contact points and the electrical resistance of the polymer composite. The ratio of electrically conductive flakes to electrically conductive nanoparticles in embodiments of the invention may be the range of 80:20 to 40:60 or more specifically from 65:35 to 45:55.

### EXAMPLES

### Materials

In the Examples, the polymer was an epoxy. The polymer precursor includes an epoxy resin, diglycidyl ether of bisphenol A (Epon 828, Resolution Performance Products), and hardener, hexahydro-4-methylphthalic anhydride (HMPA, Lindau Chemicals). The weight ratio of epoxy resin to hardener was 1:0.75. The catalyst was 1-cyano-ethyl-2-ethyl-4-methylimidazole (2E4MZ-CN, Shikoku Chemicals Corp.).

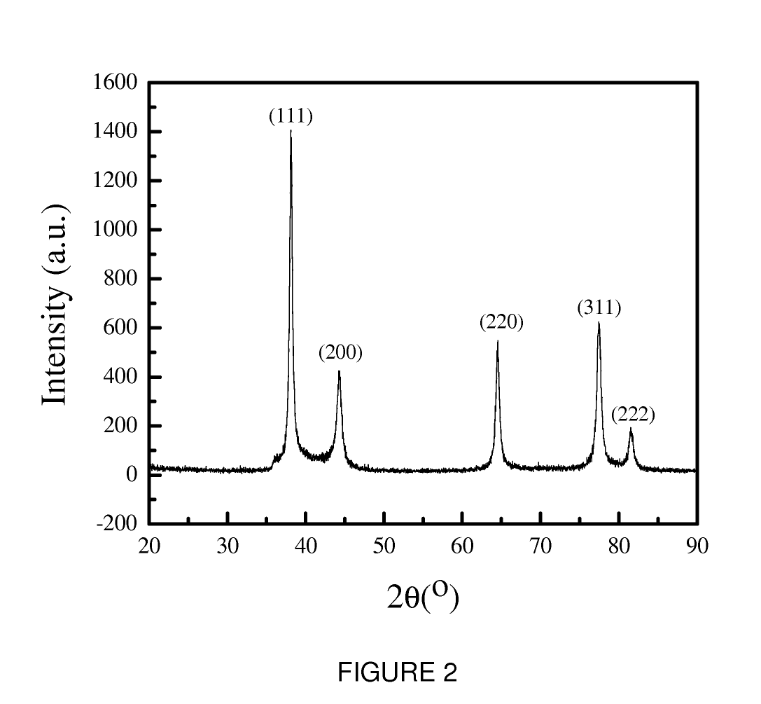

The electrically conductive nanoparticles used in the Examples were silver nanoparticles. The silver nanoparticles were synthesized by combustion chemical vapor condensation (CCVC). FIG. 2 shows the XRD patterns of the silver nanoparticles used. The average size of the synthesized silver nanoparticles calculated from X-ray diffraction (“XRD”) patterns by the Scherrer equation were calculated to be approximately 16 nm.

Diacids, such as glutaric acid, adipic acid, or malonic acid, were used as the compound that surface functionalize the silver nanoparticles with a surfactants. All the chemicals were used as received.

### Example 1

### Preparation and Analysis of Surface Functionalized Silver Nanoparticles

The molar ratio of silver nanoparticles to diacid was set to 1:1. A solution of the nanoparticles, diacid, and ethanol was sonicated for 2 hours. From the TEM studies, there are no changes for the average size and size distribution of silver nanoparticles after sonication for two hours due to the existence of surfactants. In this example, the surfactants bonded on the nanoparticle surface may prevent the nanoparticles from growing, agglomerating, or adhering. The solution was centrifuged to remove the solvent and unreacted diacid. These surface functionalized silver nanoparticles were rinsed three times by solvent. Finally, the surface functionalized silver nanoparticles were dried in a vacuum chamber for 24 hours at room temperature.

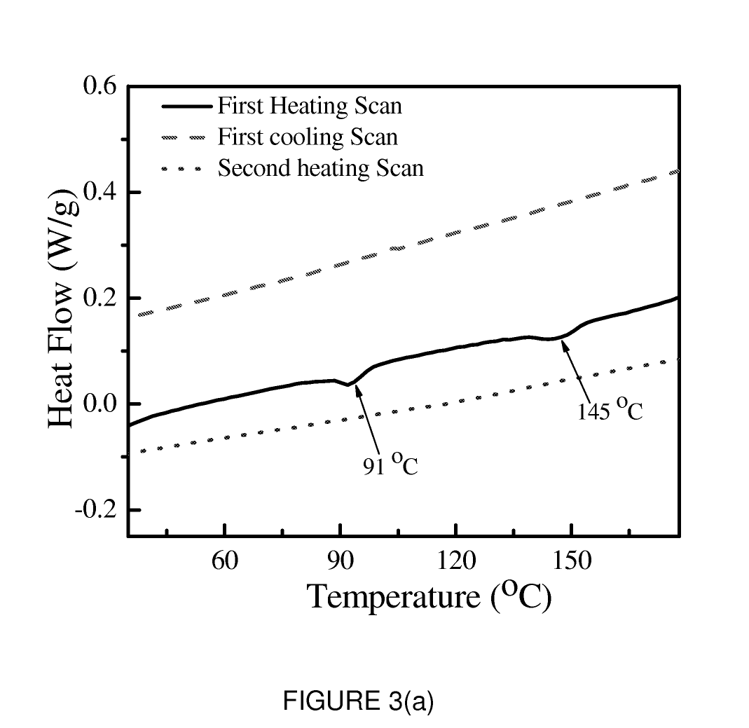

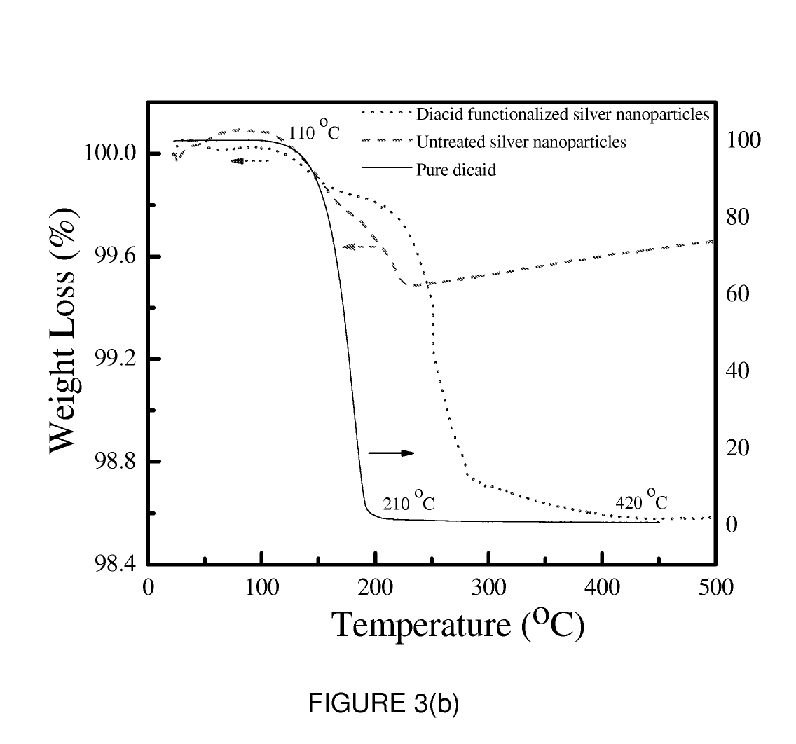

The Differential Scanning Calorimetry (“DSC”) and Thermogravimetric Analysis (“TGA”) curves of the silver nanoparticles treated by diacids are shown in FIG. 3. In the first heating scan of DSC, there was an endothermic peak at 91° C. as seen in FIG. 3(a) which corresponds to the melting point of the diacids. The DSC revealed another endothermic peak at 145° C., also seen in FIG. 3(a), which is possibly temperature at which diacids were debonded from silver nanoparticles or the debonding temperature. This peak was not present in the second heating scan, indicated no surfactant was left bonded to the nanoparticles.

The graph of the TGA analysis, FIG. 3(b) showed that the amount of diacids bonded to silver nanoparticles was around 1.2 wt %. For the pure diacid, more than 95 wt % decomposition happened between 110° C. and 210° C. For the functionalized silver nanoparticles, the decomposition between 110° C. and 210° C. may come from the contaminants on the silver particle surface and some pure diacids, while the rest (with chelating bonds between silver and acid groups) gradually decomposed from 210° C. to 420° C. Lee, et al. also found this kind of decomposition behavior from their mercaptosuccinic acid (“MSA”) coated silver nanoparticles. Both the DSC and TGA results confirmed the existence of diacids bonded to silver nanoparticles.

In order to further provide evidence of the debonding behaviors between surfactants and nanoparticles, the morphologies of silver nanoparticles functionalized by diacids in the powder form after annealing at 100° C. and 150° C. for 30 minutes were studied, respectively. FIG. 4 includes photomicrographs of the morphologies of silver nanoparticle powders before and after various heat treatment methods. FIG. 4(a) is a photomicrograph of non-annealed surface functionalized silver nanoparticles showing unsintered nanoparticles. FIG. 4(b) is a photomicrograph of surface functionalized silver nanoparticles annealed at 150° C. for 30 minutes, depicting sintered electrically conductive nanoparticles. FIG. 4(c) is a photomicrograph of untreated silver nanoparticles annealed at 100° C. for 30 minutes, showing the degree of sintering of the untreated particles at the lower annealing temperature. FIG. 4(d) is a photomicrograph of surface functionalized silver nanoparticles annealed at 100° C. for 30 minutes showing the degree of sintering of the functionalized nanoparticles at the lower annealing temperature. Comparing the images of FIG. 4(a) and FIG. 4(b), it can be seen that after annealing at 150° C. for 30 minutes, the silver nanoparticles functionalized by diacids showed sintered morphologies. Not wishing to be bond by any theory, it is believed that during the annealing process, the surfactants were debonded from the nanoparticles, as indicated by the DSC analysis, and then the nanoparticles were sintered at 150° C.

The diacids surface functionalized nanoparticles and untreated silver nanoparticles in the powder form were annealed at 100° C. for 30 minutes, respectively. Morphology studies, see FIG. 4(c) and FIG. 4(d), indicate that the untreated silver nanoparticles were obviously sintered and the color of the powder changed to white (FIG. 4(c)), while the functionalized silver nanoparticles were only slightly sintered and the color of the powder was still black (FIG. 4(d)). This result is explained because at the lower annealing temperature of 100° C., the surfactants were not debonded from the nanoparticles and therefore still bonded to the nanoparticle surfaces. It is believed that the surfactants inhibited the nanoparticle sintering.

### Example 2

### Preparation of Polymer Composites

Composite precursors were prepared by mixing different molar ratios of surface functionalized silver nanoparticles and silver flakes with the polymer precursor comprising a mixture of bisphenol A and hexahydro-4-methylphthalic anhydride. The composite precursor was sonicated for one hour and then the catalyst was incorporated. The composite precursor was again sonicated for 5 minutes.

### Example 3

### Characterization of the Surface Functionalized Silver Nanoparticles

Thermogravimetric Analysis (TGA, 2050 from Thermal Advantages Inc.) was used to investigate the weight loss of the surface functionalized silver nanoparticles. The debonding temperature between the surfactant and silver nanoparticles was determined by a standard differential scanning calorimeter (DSC, TA Instruments, model 2970). A sample of about 10 mg of surface functionalized silver nanoparticles prepared in Example 1 were placed into a hermetically sealed DSC sample pan and placed in the DSC cell under a 40 ml/min nitrogen purge. Non-isothermal scans were made at a heating rate of 5° C./min. After the non-isothermal scan, the sample was cooled to room temperature and then re-scanned under the same condition. For morphology studies, field emission scanning electron microscopy (FE-SEM, JEOL 1530) was used.

### Example 4

### Curing and Measurement of the Electrical Properties of Polymer Composites

Resistivity of the polymer composites prepared in Example 2 was determined from the bulk resistance of the specimen with specific dimensions. Two strips of a Kapton tape (DuPont) were applied onto a pre-cleaned glass slide. The formulated composite precursors were doctor-bladed in-between the two strips, and cured at 150° C. for 90 minutes. The Kapton tapes were then removed. The thickness of the cured film was determined by Heidenhain (thickness measuring equipment, ND 281 B, Germany).

The silver flakes and surface functionalized silver nanoparticles were incorporated into the epoxy resin to form the polymer composites and the electrical resistivity of the polymer composites was measured. The surface functionalized silver nanoparticles and silver flakes were loaded up to 80 wt % of the total polymer composite.

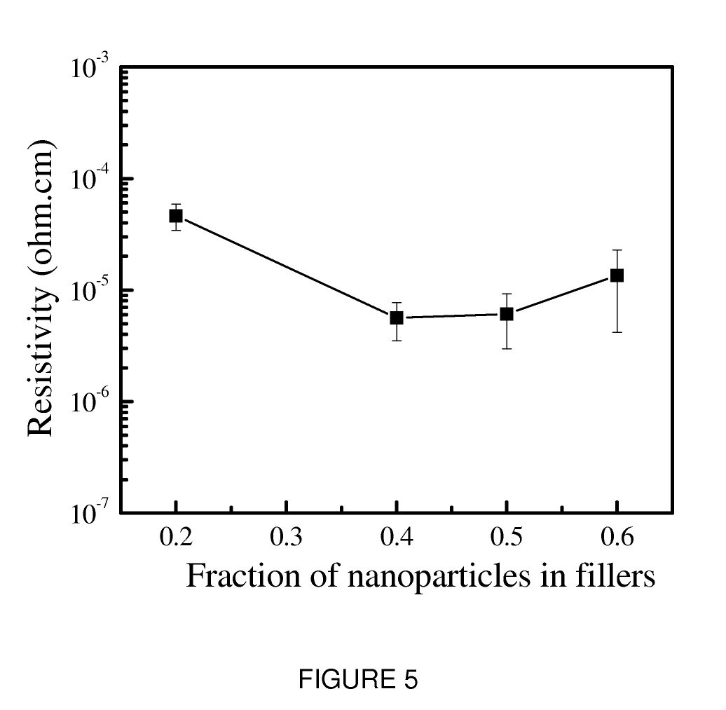

FIG. 5 is a graph of the curves of the bulk resistivity of the polymer composites with various ratios of microparticle silver flakes to surface functionalized silver nanoparticles. The resistivity could be achieved as low as 5×10⁻⁶ Ω·cm, which is close to that of bulk silver (2×10⁻⁶ Ω·cm) and lower than that of eutectic Sn/Pb solder (1.7×10⁻⁵ Ω·cm). The small standard deviations of each formulation in FIG. 5 show the good reproducibility of this process. However, when the same amount of untreated silver nanoparticles and silver flakes were used as conductive fillers, the resistivity would be 2×10⁻⁶ Ω·cm, twelve orders of magnitude higher than that of surface functionalized silver nanoparticles and silver flakes incorporated one.

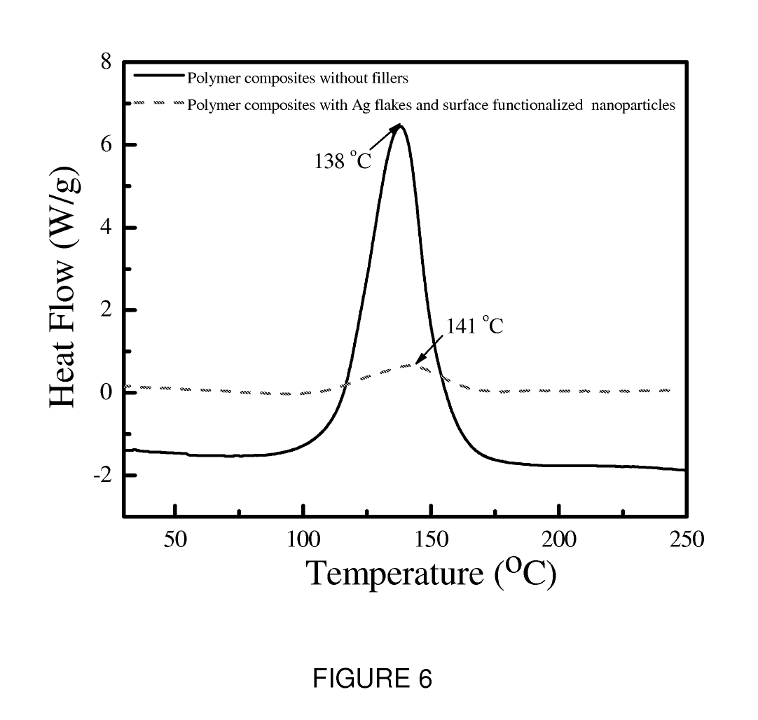

The curing profiles of the polymer composites without fillers and with silver flakes and surface functionalized silver nanoparticles as conductive fillers are shown in FIG. 6. The peak temperatures in the curing profiles for the two formulations were 138 and 141° C., respectively. The total heat of reaction of the unfilled epoxy formulation was 316 J/g, while that of the silver flakes and surface functionalized silver nanoparticles incorporated polymer composites was 162 J/g which was normalized with respect to the epoxy weight in the formulations. It can be seen that the formulation with silver flakes and surface functionalized silver nanoparticles has a lower heat of fusion during curing. This is due to the lower crosslinking density of the epoxy resin. The mechanism of the epoxy resin curing in this study is that the active imidazole group of the catalyst used reacts with epoxy molecules at the 1-N position to form an adduct which contains a highly reactive alkoxide ion. This alkoxide ion will continue to initiate the rapid anionic polymerization of the epoxy resin and form a crosslinked structure. But due to the existence of diacids, it will react with an imidazole group to create a salt form, which may result in the loss of the catalyzing ability of the imidazole group. In addition, the carboxylic acid can also initiate the epoxy curing reaction, but its catalyzing ability is much weaker, which may lead to the lower crosslinking density of epoxy resins. In order to verify the influence of the diacid on the curing behavior of the epoxy resin, the diacid was incorporated into the unfilled epoxy formulation. It was found that the total heat of reaction of this formulation was 179.8 J/g. This is very close to that of the formulation with surface functionalized silver nanoparticle and silver flakes.

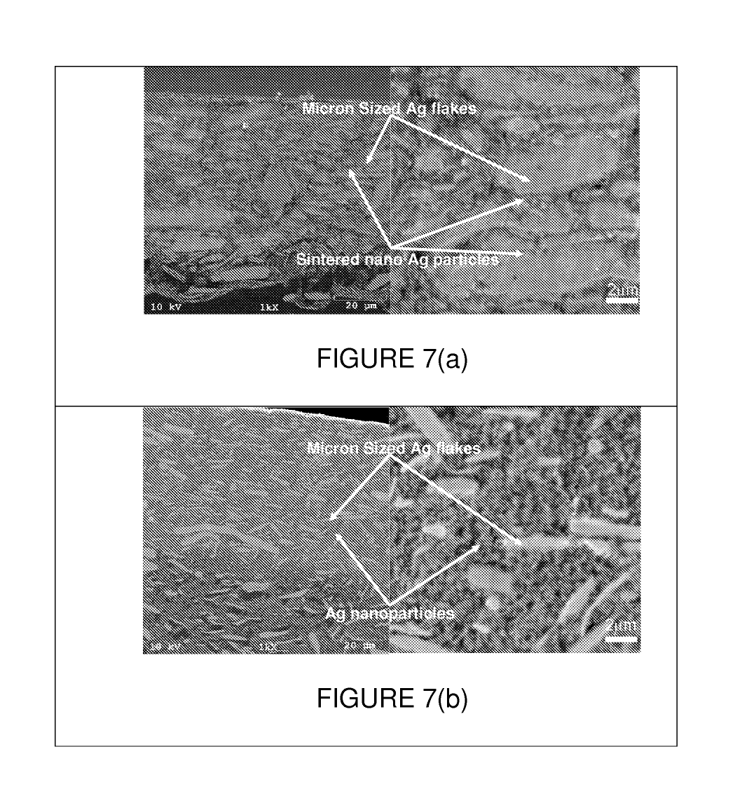

FIG. 7(a) shows the morphologies of the polymer composites filled with silver flakes and surface functionalized silver nanoparticles at a ratio of 60:40. It can be seen that the silver nanoparticles obviously sintered in-between the silver flakes and formed a significantly condensed structure. This sintered structure results in reducing the number of the interfaces between fillers and lowering the electrical resistivity. The mechanism for silver nanoparticles sintering by aids from diacids could be that the diacid is first adsorbed onto silver nanoparticle surfaces. This will help the dispersion of the nanoparticles in the epoxy resin which enables a higher filler loaded formulation. During the curing process, the diacid is debonded from the silver nanoparticles at a certain temperature. The debonded diacid may act as a flux to reduce the silver oxide layer covered on the silver nanoparticles due to the reaction between the carboxylic acid and silver oxide. This fluxing process aids the sintering process of silver nanoparticles, which decreases the number of contact points between the particles resulting in lower electrical resistivity. FIG. 7(b) are the morphologies of the polymer composites with silver flakes and untreated silver nanoparticles as conductive fillers, where the nanoparticles are not sintered very well. Significant amounts of non-sintered silver nanoparticles and the separation between silver flakes and silver nanoparticles are observed, which attributes to the high electrical resistivity.

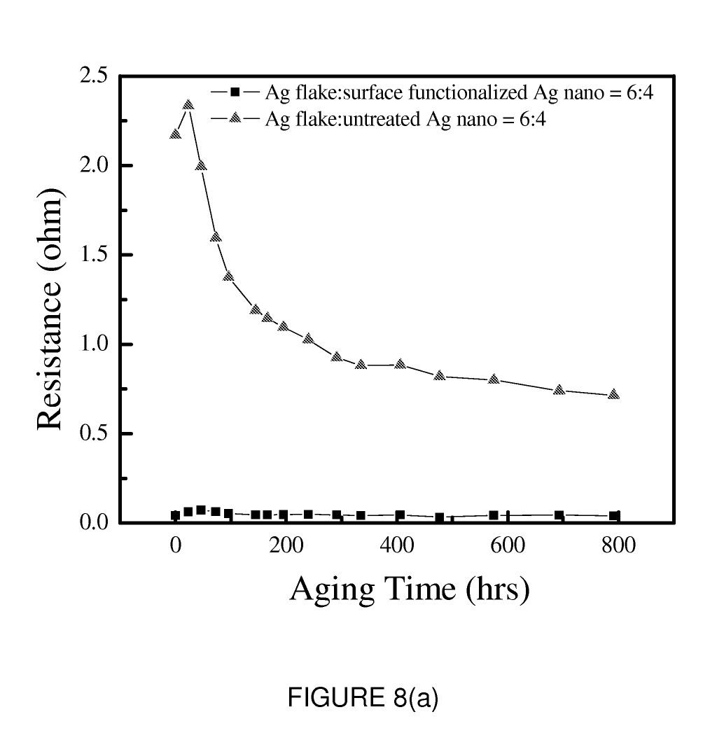

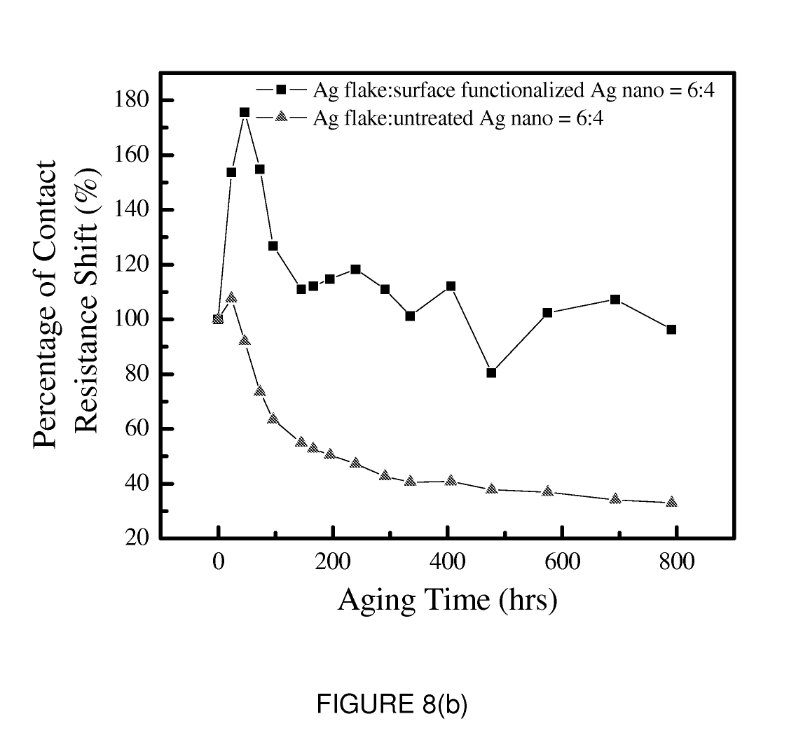

FIG. 8(a) shows the contact resistance of polymer composites with different kinds of fillers on Ni/Au surfaces during 85° C./85% RH aging. The Ni/Au surface is relatively inert and non-corrosive under high humidity. The contact resistance of the polymer composites with silver flakes and surface functionalized silver nanoparticles is much lower than that with silver flakes and untreated silver nanoparticles. FIG. 8(b) shows the percentage of contact resistance shift with the increase of aging time. In the first several hours, the contact resistance increased because of moisture from 85° C./85% RH, while the contact resistance decreased with increasing aging time. This may be due to that the nanoparticles sintering proceeded further and polar water molecules were absorbed into the composite materials. The sintering process is dependent upon various parameters such as temperature, pressure, time, the surface status of the powder and the powder size. Further studies on effects of these parameters on the sintering behavior of silver nanoparticles in the polymer resins are needed.

Polymer composites with ultra-low electrical resistivity (˜5×10⁻⁶ Ω·cm) were successfully created by using the combination of micron sized silver flakes and surface functionalized silver nanoparticles. The morphology studies revealed that this low resistivity was accomplished by dramatic reduction of the number of interfaces between conductive fillers due to low temperature sintering of silver nanoparticles. In addition, the thermal analysis showed that the surfactant aided the sintering process by means of maintaining nanoparticle surfaces clean in the polymer resin and debonding before the gelation of the epoxy resin. The contact resistance of the formulation on Ni/Au surfaces decreased with aging time under 85° C./85% RH. This may be because of further sintering of the nanoparticles under the elevated temperature and humidity.

1. A method of forming a polymer composite, comprising:
mixing conductive metal flakes, functionalized conductive metal nanoparticles, and a polymer precursor to form a composite precursor;
curing the polymer precursor to form the polymer composite; and
sintering the conductive metal nanoparticles.

2. The method of claim 1, wherein the conductive metal of flakes and nanoparticles are at least one of silver, iron, copper, nickel, chromium, gold, platinum, palladium or combinations thereof.

3. The method of claim 1, comprising:
reacting conductive metal nanoparticles with a compound, wherein the compound reacts with the silver nanoparticle to form the functionalized conductive metal nanoparticles comprising a surfactant.

4. The method of claim 3, wherein the compound is at least one of a monocarboxylic acid, diacid, dicarboxylic acid or an organic surfactant.

5. The method of claim 3, wherein the surfactant is either coordinated with or ionically bonded to the functionalized conductive metal nanoparticle.

6. The method of claim 3, wherein the surfactant may be thermally debonded from the conductive metal nanoparticle at or above a debonding temperature.

7. The method of claim 7, wherein a portion of the surfactant is thermally debonded from the conductive metal nanoparticle during curing of the polymer.

8. The method of claim 3, wherein the surfactants are at least partially thermally debonded from the conductive metal nanoparticles prior to sintering of the conductive metal nanoparticles.

9. The method of claim 7, wherein the sintering is conducted at a temperature above the debonding temperature.

10. The method of claim 4, wherein the compound is a dicarboxylic acid.

11. The method of claim 2, wherein the conductive metal is silver.

12. The method of claim 1, wherein the polymer is a thermoplastic or thermosetting polymer.

13. The method of claim 12, wherein the polymer is a polyester.

14. A polymer composite, comprising:
a polymer; and
electrically conductive filler comprising silver flake and sintered electrically conductive nanoparticles between the silver flake.

15. The polymer composite of claim 14, wherein the polymer composite is an electrically conductive polymer composite.

16. The polymer composite of claim 15, wherein the polymer composite has an electrical conductivity of less than 10⁻⁵ Ω·cm.

17. The polymer composite of claim 14, wherein the polymer is a thermoplastic or thermosetting polymer.

18. The polymer composite of claim 17, wherein the polymer is an epoxy.

19. The polymer composite of claim 14, wherein the electrically conductive filler comprises silver, iron, copper nickel, chromium, gold, platinum, palladium, or combinations thereof.
